(19) United States
(12) Patent Application Publication
(10) Pub. No.: US 2009/0108497 A1
(43) Pub. Date: Apr. 30, 2009

(54) HIGH SPEED MANUFACTURE OF INJECTION-MOULDED PART

(75) Inventor: Dominique CHASLIN, Ratenelle (FR)

Correspondence Address: DENNISON, SCHULTZ & MACDONALD, 1727 KING STREET, SUITE 105, ALEXANDRIA, VA, 22314, US

(73) Assignee: ALCAN PACKAGING BEAUTY SERVICES, Gennevilliers (FR)

(21) Appl. No.: 12/257,116

(22) Filed: Oct. 23, 2008

(30) Foreign Application Priority Data
Oct. 26, 2007 (FR) 07 07536

(51) Int. Cl. B29C 45/04; B29C 45/56; B29C 45/06

(52) U.S. Cl. 264/297.3; 264/40.7; 425/549; 425/576

(57) ABSTRACT

A multi-cavity moulding process, using a moulding tool including an injection head integral with the injection press and a moulding assembly, the plastic material being injected under pressure and distributed in runners provided in the injection head which is equipped with heating elements, the moulding assembly including two mobile parts the assembly of which allows the mould cavities to be formed and the spreading of which allows the moulded parts to be ejected. The moulding assembly also includes a manoeuvring device that opens, closes and locks the mobile parts, where none of the mobile parts (30 and 40) of the moulding assembly is secured to the injection head, the moulding assembly coming into contact with the injection head and bearing on it only when it is closed in position and locked in order to fill the mould cavities.

### BACKGROUND OF THE INVENTION

The invention concerns a high-speed manufacturing process for producing injection-moulded parts. We shall illustrate this process by using flexible tube heads or flexible tube blanks as the moulded parts, which must be manufactured at rates exceeding 100 parts per minute, typically between 200 and 400 parts per minute.

The flexible tubes are intended to store and distribute fluid to pasty products, such as cosmetic products, pharmaceutical products, hygiene products or food products. They have a head made of plastic material(s), including a shoulder and a neck equipped with a dispensing orifice, and a flexible cylindrical skirt (axisymmetrical or otherwise) made of one or more plastic materials.

Generally speaking, the flexible tubes are made by assembling two parts manufactured separately: a flexible cylindrical skirt of given length (typically 3 to 5 times the diameter) and a head comprising a neck with dispensing orifice and a shoulder connecting said neck to the cylindrical skirt. The head made of plastic material(s) can be moulded separately then welded onto one end of the skirt although it is advantageously moulded and welded in an autogenous manner using either an injection moulding technique (FR 1 069 414) or a compression moulding technique of an extruded blank (FR 1 324 471). The previous techniques are based on the assembly of two parts produced separately owing to the fact that flexible tubes moulded in one piece from the same plastic material were long considered as being unsuitable for prolonged use: in order to produce a tube with a high slenderness ratio presenting a very thin wall thickness in relation to its diameter, a material with a slow melt-index must be selected. Unfortunately, this property is correlated with high susceptibility to stress cracking. For some time, however, certain polymeric materials have appeared on the market, enabling the moulding of flexible tubes in one piece to be considered. Thus, EP 0 856 554 (L'OREAL) recommends injection moulding of a mix of ethylene-olefin copolymers in C4 to C5 and ethylene-polyolefin copolymers in C6 to C10. French patent FR 2 731 983 (MOMIPLAST), European patent application EP 0 981 431 (I.O.M Jacobs), and European patent EP 1 263 569 (CEP Industrie) disclose also the moulding of a flexible tube in one piece by the injection of special plastic materials.

The “conventional” manufacturing processes, which rely on the assembly of a head and a skirt, were developed more than fifty years ago. As such, FR 1 114 708 discloses a device designed to manufacture tubes at high speeds, owing to the use of moulding assemblies mounted on an indexed rotary table operating step-by-step and serving several workstations, including the supply of the skirts, the overmoulding of the heads on the skirts, pressurised cooling, stripping and removal of the tubes. These devices have since been perfected, particularly by increasing the number of workstations and equipping the rotary table to receive moulding assemblies that consist of several mould cavities each. Typically, current machines are made up of 5 to 10 workstations and moulding assemblies comprising 2 to 8 mould cavities.

In these moulding assemblies, each mould cavity is made up of two parts of a mould being placed together: a punch and a die. In the technique referred to as overmoulding of the head on the skirt, the skirt arrives to the workstation and is fitted around a punch, one of its ends extending slightly past the end of the punch. Said punch end acts as a mould to create the internal surface of the tube head (inside of the shoulder and neck). As a background task, while the table is rotating for example, the die is placed against the end of the punch, the cavity of this die defining the outside surface of the shoulder and the neck. When the assembly arrives to the moulding station, the end of the skirt, which extends past the punch, is captured in the cavity defined by the end of the punch and the die cavity. The plastic material, under the influence of the injection pressure, flows and comes into contact with the end of the skirt. While at a temperature greater than its Vicat softening temperature and at that of the skirt, it welds intimately with the end of the skirt without the addition of any other heat or material. After slight pressure is held (in the order of a few seconds corresponding to the passage of the moulding assembly through one or several workstations downstream from the moulding station) and after cooling, the tube obtained is stripped and removed. The moulding assembly thus released, the punches, pulled away from the dies, are ready to receive a new skirt for moulding a new tube.

In the process described previously, the mould cavities are supplied with plastic material via a cold runner system, which involves the formation of sprues and thus requires subsequent operations to remove these sprues. The creation of said sprues and their removal present several drawbacks: other machines must be included in the production line, the removal of the sprue generally results in the creation of the tube's dispensing opening, the dimensional precision constraints must be respected at the cut, which requires slower production rates. Furthermore, the plastic waste resulting from the cut must be managed: removal, recycling of the sprues and the chips . . . .

To avoid the formation of sprues, the hot runner supply technique should be used, but this requires the use of more complex, costly and larger moulding tools, which particularly include temperature measurement devices and heating devices. As these tools are generally multi-cavity, these devices are used only to maintain the plastic material at a certain temperature although are part of a complex system that allows the flow of material to be balanced (by the temperature and by the length and cross-section of the channels) while the cavities are being filled.

FIG. 1 schematically illustrates such a technique: in an injection press 100 of prior art, the plastic material enters a plastification device—typically a mixing screw—then is conveyed toward the moulding tool passing through an injection unit 110. Here, the injection unit 110 is illustrated by a device integral with the injection press plate 120 and comprising the supply, melting and injection functions: it includes a reciprocating screw 111 sliding through an annular valve 112. The stroke of the reciprocating screw 111 through the valve 112 enables the quantity of material injected to be controlled. As the reciprocating screw 111 progresses through the valve 112, the plastic material is injected under pressure and flows into the distribution block 210, through the channel 201 which divides—preferably in several stages where the flow is split in half each time—into as many distribution channels 205 as there are cavities to be filled. The plastic material then passes through the injection nozzles 215 which are mounted to the distribution block 210 and which open in the mould cavities 300 created in the moulding assembly 250. The distribution block 210, the injection nozzles 215 and/or the casing 220 which receives them are furthermore equipped with heating elements (not illustrated) enabling one part to maintain the plastic material at temperature in said channels when the moulding tool is open to remove the moulded part and enabling the flows of plastic material to be balanced while the cavities are filled. The moulding assembly 250 comprises two parts that are mobile in relation to one another, the assembly of which allows mould cavities to be formed and the spreading of which allows the moulded parts to be ejected. The fixed part 230 is integral with the casing 220 wherein the distribution block 210 and the injection nozzles 215 are placed and the casing 220 is itself secured to the plate 120 of the injection press 100. A manoeuvring device (not illustrated) of the mobile part 240 opens, closes and locks the mould by exerting a sufficient force to prevent the tool from opening during injection. Generally speaking, particularly when a hot runner supply system is used, the moulding tool is multi-cavity.

The moulding assembly 250 illustrated in FIG. 1 is intended to produce a flexible tube and includes moulds in two parts: a male part, referred to as the punch 241, and a female part, referred to as the die 231. The dies 231 are housed in the fixed part 230, referred to here as the die-carrier assembly and the punches 241 are housed in the mobile part 240, referred to here as the punch-carrier assembly. The moulding tool 200 includes the punch-carrier assembly 240 and the group formed by the die-carrier assembly 230, the casing 220, the distribution block 210 and the injection nozzles 215, all these parts being maintained integral between themselves and being mounted, via the casing 220, to the plate 120 of the injection press. Only the punch-carrier 240 is mobile in relation to the group 230+210+215+220 and is pulled away from the latter to remove the moulded parts. In order to produce moulded parts of different shape, the entire moulding tool 200 must be replaced.

It is noted that with an injection moulding process using a hot runner system as described above, it is difficult to manufacture parts with quantities and production rates as high as those required for flexible tubes, the order of magnitude of which is typically several hundred parts per minute. The number of cavities capable of being moulded simultaneously can certainly be increased but, for obvious practical reasons, this number can only remain limited: at best, it can reach only one or two dozen cavities per tool, even less owing to difficulties in balancing the flows during the injection process, this difficulty increasing “exponentially” with the number of cavities.

Furthermore, by Japanese patent application JP 02 261 528, a device is known comprising a moulding tool in three mobile parts that can be spread apart in the axial direction although remain integral with one another via axial pins. The first part, secured to the injection press, is an injection head wherein plastic material supply channels are provided and the two other mobile parts for the moulding assembly: bringing them together allows said mould cavities to be formed and spreading them apart—in a limited manner—allows the moulded parts to be ejected. With a device of this type, secured once and for all on the injection press although being able to be “opened” after each injection, it is possible to perform multi-cavity moulding operations with high production rates but this is possible only for producing relatively stocky parts. Furthermore, this device would appear to be difficult to adapt to the manufacture of flexible tubes since the limited axial travel of the mould's parts does not favour the introduction of skirts and their placement on the punches.

A moulding device is also known, by U.S. Pat. No. 6,616,441, enabling moulded parts to be obtained by vertical injection using two-part moulding tools: a fixed “upper” half-mould, placed at the exit of the injection press and “lower” mobile half-moulds placed on the indexed rotary table operating in a step-by-step manner. When the “lower” half-mould is taken to the moulding station, the half-moulds are aligned, then the moulding assembly thus created is closed and locked, and then the injection operation is performed. In relation to traditional “static” moulding devices, such a device allows production rates to be increased in certain cases but the injection cycle time remains quite long owing to difficulties in aligning the half-moulds. Furthermore, in this document it is not foreseen to place skirts in the cavities and, if the inclusion of such an operation is considered, it can only be performed on the injection station, which can only further prolong the cycle time corresponding to said injection station.

### SUMMARY OF THE INVENTION

The applicant thus sought to develop a moulding process presenting neither the drawbacks of the known processes using the cold runner system nor those using the hot runner supply system.

A first subject according to the invention is a simultaneous injection moulding process of plastic material in several mould cavities, wherein a moulding tool is used comprising an injection head integral with the injection press and a moulding assembly, the plastic material being injected under pressure by passing through distribution channels provided in said injection head and maintained at temperature, the moulding assembly comprising two parts mobile in relation to one another, the assembly of which allows mould cavities to be formed and the spreading of which allows the moulded parts to be ejected, the moulding assembly also comprising a manoeuvring device that opens, closes and locks said mobile parts and exerts sufficient force to prevent opening during injection, wherein none of the mobile parts of the moulding assembly is secured to the injection head, the moulding assembly coming into contact with said injection head and bearing against it only when it is in closed position and locked in order to fill the mould cavities by injecting plastic material.

The process according to the invention is a moulding process using a hot runner supply system. The runners are maintained at temperature using heating devices provided in the injection head in the vicinity of said runners. This process can be implemented regardless of the number of mould cavities to be filled simultaneously although it is clear that it becomes really interesting only if the number of cavities is at least equal to two. In the scope of the process according to the invention, a moulding tool comprising an injection head is used that remains integral with the injection press and a moulding assembly is used that can be easily removed from the injection head, thus from the injection press. None of the mobile parts of the moulding assembly is secured to the injection head. The moulding assembly comes into contact with the injection head and bears against it only once it has been closed and locked for the purpose of filling the mould cavities. This process thus differs from the prior art in that the block containing the hot runners, separated from the rest of the moulding tool, can be mounted to the injection press plate for a very long time.

With this configuration, the same injection head can be used for a large number of moulding tools which, having no distribution block, injection nozzles or casing, are much less bulky, much less expensive to manufacture and much easier to move. The injection head is thus a special part intended to remain mounted for a long time on the injection press plate, subject only to the number of cavities to be filled, regardless of their shapes, the only constraint being to respect dimensions that are compatible with the arrangement of the runner outlets of said head. The injection head may thus remain permanently fastened to the injection press, while the moulding tools intended to be supplied by this head include exactly the same number of cavities, and even, as in a preferred embodiment described below, while the moulding tools intended to be supplied by this head comprise a number of cavities less than or equal to the number of runner outlets.

For the same shape of part to be moulded, the configuration of the tooling according to the invention allows for exceptional gains in productivity since, once the injection is done, the moulding assembly can be rapidly removed and replaced by another moulding assembly, while the cooling of the moulded parts and the unlocking of the mould elements to remove said moulded parts can be performed separately, that is as a background task in relation to the injection press cycle.

Besides this, the injection head, required to remain immobile and be used for a large number of moulding tools, can have a structure better adapted to multi-cavity moulding, particularly comprising a set of runners and heating equipment for said runners better adapted to balancing the flows of plastic materials during the injection process, in comparison with the casing+distribution block+injection nozzle assembly used in the prior art. Individualised heating elements can be foreseen, for example, each of these heating elements being associated with a runner and being adjustable separately.

Preferably, the mobile part of the moulding assembly intended to come into contact with the injection head is equipped with an injection head on the outlet of a runner. Preferably, it is equipped with an injection head on each runner. In order to facilitate the rapid installation of the moulding assembly opposite the injection head, it is itself advantageously equipped with feed nozzles located at the outlet of the runners and opposite of which are placed said injection nozzles integral with the moulding assembly. Typically using spherical fittings, the injection nozzles are aligned with the feed nozzles when the moulding assembly comes into contact on the injection head.

Advantageously, still with the goal of perfectly controlling the balance of flows during moulding at all times, the injection nozzles are heated by a heating element, preferably individually adjustable.

Preferably, to obtain an even finer and more easily controllable balance of the flows of plastic material, the injection head is equipped with dosing actuators that are supplied by said runners and which allow a controlled quantity of material to be injected into the mould cavity associated with said runner. It is possible, for example, to provide chambers of predetermined volume in the injection head, each of these chambers being traversed by a runner. A piston, the stroke of which is preferably adjustable, moves in the chamber under the effect of an actuator, for example. When the piston is retracted, the chamber is filled with the molten plastic material. When the piston moves forward, the plastic material is injected under pressure in the direction of the associated mould cavity. As will be demonstrated in the example given below, the dosing actuator can be associated with a valve which, when the moulding assembly is not bearing against the injection head, allows the channel of the feed nozzle to be closed and the chamber of the dosing actuator to be filled and which, when the moulding assembly is bearing against the injection head, blocks the admission port of the runner in the chamber of the dosing actuator and places said chamber in communication with the channel of the feed nozzle.

Another advantage of using individualised dosing actuators resides in the injection head's flexibility of use. An injection head comprising as many dosing actuators and valves as there are runner outlets (intended to supply a mould cavity) can remain permanently fastened to the injection press, while the moulding assemblies designed to be supplied by this injection head include a number of cavities less than or equal to the number of runner outlets. To accomplish this, said dosing actuators and said valves can simply be actuated individually, typically by a control distributor, so that the dosing actuators are not actuated and to maintain closed the valves corresponding to the cavities that are not to be filled and to thus prevent the flow of plastic material through the feed nozzles.

In a particularly preferred embodiment, several moulding assemblies are mounted on an indexed rotary table operating in a step-by-step manner and serving several workstations, the injection press equipped with said injection head being placed at one of the workstations. Preferably, there is at least one moulding assembly mounted on said rotary table in each sector of said table corresponding to a workstation. The manoeuvring device that opens, closes and locks the mobile parts is preferably mounted on the rotary table. Upstream from the station where the injection press is located, said device is actuated to bring together the mobile parts of the tool, which allows said mould cavities to be formed, then the moulding assembly is closed and locked. Upon arriving to the moulding station, the moulding assembly is brought to the injection head, then is placed and held against it by means of an actuator the time required for the injection operation. It is then immediately pulled away from the injection head and the rotary table turns so that it passes to the stations located downstream from the injection station, in order to cool then remove the moulded part. The injection station is then ready to receive the next moulding assembly.

In a preferred embodiment of the invention, illustrated by the detailed example below, the moulding assembly is actuated in the direction of the injection head by means of an actuator located outside the rotary table, placed at the workstation where the injection press is located. In this case, one of the mobile parts of the moulding assembly is mounted on said rotary table so that it can slide along an axis parallel to the axis of rotation of said rotary table so that, when the moulding assembly is presented, its mobile parts closed and locked, said actuator, also acting along the axial direction, drives said moulding assembly toward the injection head and exerts a bearing force throughout the entire duration of the injection.

A rotary table divided into n sectors can be used, n being an integer typically between 2 and 24, each sector being occupied by m moulding assemblies, m being an integer typically between 2 and 8, each of the mobile parts of a moulding assembly possibly being grouped with the corresponding mobile parts of other moulding assemblies in such a manner so that there are only two assemblies of m mobile parts to be actuated in order to open, close and lock m moulding assemblies.

The procedure according to the invention is particularly well adapted to the moulding of bodies having rotational symmetry and at least one open end, such as flexible tube blanks or any other recipient having a bottom, possibly equipped with an orifice, connected by one end to a cylindrical or conical side wall, the other end of which is open. The mobile ports of the moulding assembly thus include punches that are used to form the inside of these bodies and dies that are used to form the outside. The punches are housed in punch carriers that are preferably mounted so that they slide axially on the rotary table. The dies are advantageously mounted in the die-carrier assemblies that also house the injection nozzles, which are preferably heated. Advantageously, an injection nozzle is associated with each die.

Upstream from the injection station, at a stage where the moulding assembly is still open, one or several stations can be provided that are dedicated to placing parts, inserts or labels in the cavity of one of the mobile parts of the moulding assembly. Tubes can be produced by overmoulding tube heads, for example, on the ends of skirts (extruded or rolled and welded) which were previously fitted around punches, said ends extending over the shoulder of the punches so that they are captured in the mould cavities formed by bringing the dies and punches together. Obviously, the placement of these parts, skirts, inserts and labels can be performed automatically, at a rate compatible with those of the other operations, particularly the injection moulding operation. Downstream from the supply station, preferably automatic, in terms of skirts, inserts, labels and other parts, it is advantageous to install a device to control the presence and/or correct positioning of said parts in the mould cavities: in the event a defect is detected in a cavity, action can typically be taken by means of a control distributor, on the actuator of the dosing actuator and to maintain closed the valve associated with the faulty cavity, so that injection does not take place in said cavity.

Another subject according to the invention is a moulding tool comprising an injection head designed to be mounted on an injection press and a moulding assembly, said injection head comprising runners and being equipped with heating elements, the moulding assembly comprising two mobile parts that are mobile in relation to one another and the assembly of which allows mould cavities to be formed and the spreading apart of which allows the moulded parts to be ejected, said moulding assembly also comprising a manoeuvring device that opens, closes and locks said mobile parts and exerts sufficient force to prevent opening during injection of the plastic material, wherein none of said mobile parts of the moulding assembly are secured to the injection head, the moulding assembly coming into contact with said injection head and bearing against it only when it is in closed position and locked in order to fill the mould cavities by injecting plastic material.

Preferably, the mobile part of the moulding assembly intended to come into contact with the injection head is equipped with an injection head on the outlet of a runner. Preferably, it is equipped with an injection head on each runner. Advantageously, the injection head is equipped with feed nozzles located at the outlet of the runners and opposite of which are placed said injection nozzles. Said injection head is preferably equipped with at least one valve that blocks the channel of the feed nozzle when the moulding assembly is not bearing against said injection head. Advantageously, said injection nozzles are heated by a heating element, preferably adjustable individually. Preferably, the injection head is equipped with dosing actuators that are supplied by said runners and that allow a controlled quantity of material to be injected into the mould cavity associated with said runner. Preferably, the dosing actuator is associated with a valve which, when the moulding assembly is not bearing against the injection head, allows the channel of the feed nozzle to be closed and the chamber of the dosing actuator to be filled and which, when the moulding assembly is bearing against the injection head, blocks the admission port of the runner in the chamber of the dosing actuator and places said chamber in communication with the channel of the feed nozzle.

Another subject of the invention is a machine for the high-speed moulding of plastic parts, comprising an injection press and at least one moulding tool according to the invention as described above, which also includes a indexed rotary table operating in a step-by-step manner and serving several workstations, said injection press equipped with said injection head being placed at one of the workstations, at least one moulding assembly being mounted on said rotary table. Preferably, there is at least one moulding assembly mounted on said rotary table in each sector of said table corresponding to a workstation. The manoeuvring device that opens, closes and locks the mobile parts is preferably mounted on the rotary table. In a preferred embodiment of the invention, illustrated by the detailed example below, the moulding assembly is actuated in the direction of the injection head by means of an actuator located outside the rotary table, placed at the workstation where the injection press is located. In this case, one of the mobile parts of the moulding assembly is mounted on said rotary table so that it can slide along an axis parallel to the axis of rotation of said rotary table so that, when the moulding assembly is presented, its mobile parts closed and locked, said actuator, also acting along the axial direction, drives said moulding assembly toward the injection head and exerts a bearing force throughout the entire duration of the injection.

In practice, said machine can comprise a rotary table divided into n sectors, n being an integer typically between 2 and 24, each sector being occupied by m moulding assemblies, m being an integer typically between 4 and 8, each of the mobile parts of a moulding assembly possibly grouped with the corresponding mobile parts of other moulding assemblies in such a manner so that there are only two assemblies of m mobile parts to be actuated to open, close and lock m moulding assemblies.

### BRIEF DESCRIPTION OF THE DRAWINGS

FIG. 1 schematically illustrates a device of prior art representative of the devices used within the scope of the moulding process with a runner supply system.

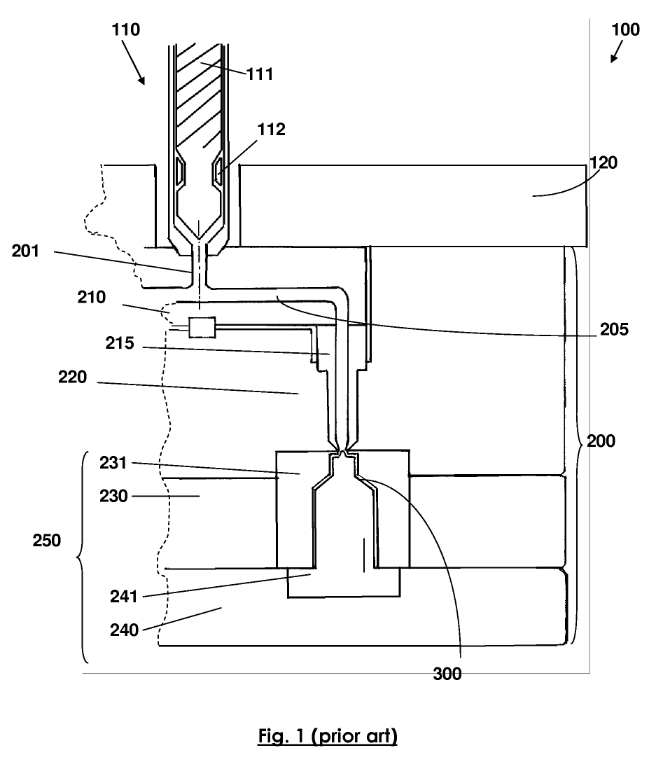

FIG. 2 schematically illustrates a device used in the scope of the moulding process according to the invention.

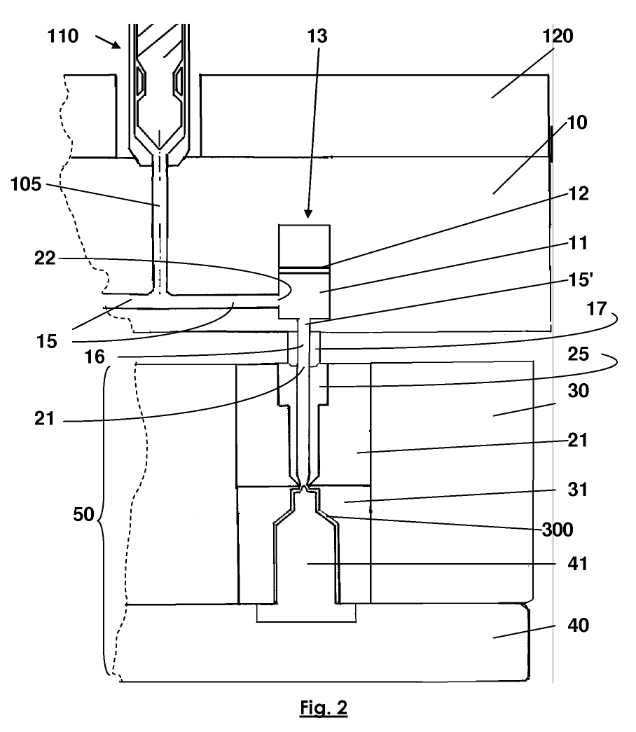

FIG. 3 represents a side view of a high-speed moulding machine according to the invention, where only the injection unit, the injection head, the moulding assembly and the periphery of the rotary table (dashed line) are represented.

FIG. 4 represents a front view of the machine illustrated in FIG. 3, where only the injection head, the moulding assembly and part of the rotary table (dashed line) are represented.

FIG. 5 represents a cross-sectional front view detailing a moulding assembly according to the invention used with the machine illustrated in FIGS. 3 and 4.

### DESCRIPTION OF THE PREFERRED EMBODIMENTS

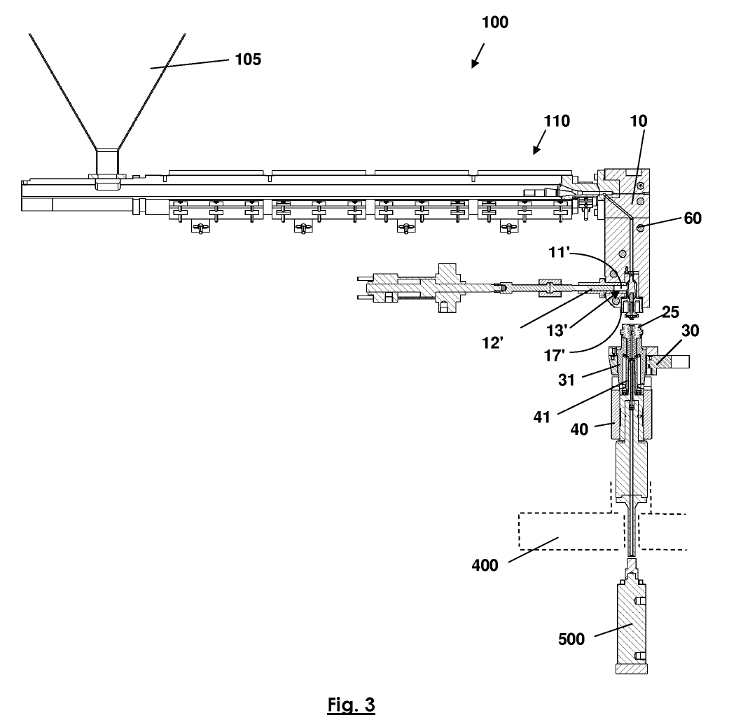

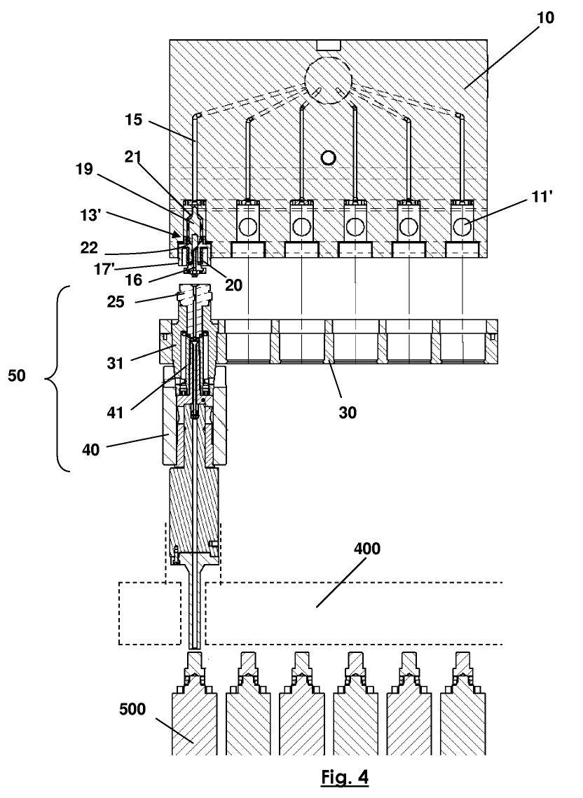

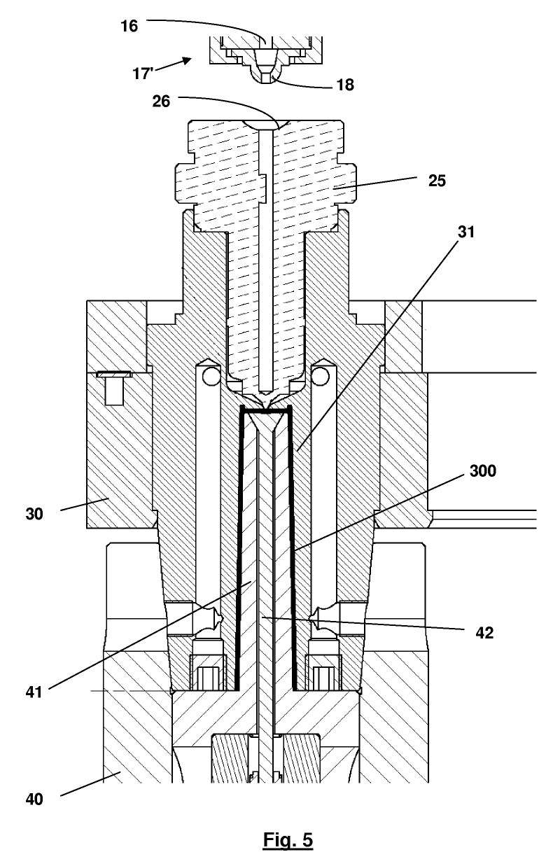

### Example (FIGS. 3 to 5)

The machine illustrated in FIGS. 3 to 5 is used to mould 180 plastic parts per minute, represented in this example by a flat-bottomed recipient with a slightly conical side wall.

It comprises an injection press 100 on which is mounted an injection head 10 and a rotary table 400 with five sectors each equipped with a group of 6 moulding assemblies 50. The rotary table 400 is indexed and operates in a step-by-step manner in order to serve five workstations. One of these stations is used to remove the moulded parts. Another of these stations is used for the injection of the moulded parts. This station includes the injection press 100 and the actuators 500 which allow the moulding assemblies 50 to be placed against the injection head 10 secured to the plate of the injection press.

The injection press 100 is represented in FIG. 3 by only the injection unit 110 and the feed hopper 105 of the injection unit 110, by which the mixing screw is fed with pellets of plastic material. The plastic material is injected, being distributed through the runners 15 created in the injection head 10. The injection head 10 is equipped with heating elements 60.

One single moulding assembly 50 is represented in the figures: it comprises two mobile parts, a die 31 and a punch 41. In this particular case, the 6 dies 31 of a same sector of the rotary table 400 are grouped together in a die-carrier assembly 30 and the six punches 41 are grouped together in a punch-carrier assembly 40. It is the die-carrier assemblies 30 and the punch-carrier assemblies 40 that are actuated—by an actuator not represented here—in order to open, close and lock the 6 moulding assemblies 50.

Neither the punch-carrier assembly 40, nor the die-carrier assembly 30 are secured to the injection head 10. The 6 moulding assemblies come into contact with the injection head 10 and bear against it only once they are in closed position and locked for the purpose of filling the mould cavities 300.

The die-carriers 30 are also designed to house, above each die 31, an injection nozzle 25 which is designed to arrive at a feed nozzle 17′. The injection nozzle 25 is equipped with a spherical surface 26, complementary of the surface 18 of the feed nozzle 17′ to which is associated, thus enabling good alignment of said injection nozzle and said feed nozzle when said moulding assembly comes into contact with said injection head.

The injection head is equipped with dosing actuators 13′ that are supplied by said runners 15 and that allow a controlled quantity of plastic material to be injected into the mould cavity 300 associated with said runner. A chamber 11′, of predetermined volume, is connected to the runner 15. Here, it presents a shape resulting from the fusion of two bores perpendicular to one another: a horizontal bore wherein the piston 12′ of the dosing actuator travels and a vertical bore which serves as the seat for the valve 19. The stroke of the piston 12′ is adjustable, which allows fine adjustment of the quantity of material injected. When the piston 12′ is retracted, the chamber 11′ is filled with the molten plastic material coming from the runner 15. When the piston 12′ advances in the direction of the injection head 10, the plastic material is injected under pressure in the direction of the associated mould cavity 300.

The dosing actuator 13′ is associated with a valve 19, the two ends 21 and 22 of which act as plugs. The valve 19 features a protrusion extending downward so that it enters into contact with the injection nozzle 25 before it comes into contact with the injection head and that is driven upward by it. When the moulding assembly is withdrawn, it moves downward owing to a compression spring 20. When the moulding assembly 50 is bearing against the injection head 10, the valve 19 is in high position, which plugs, by means of the plug 21, the admission port of the runner 15 in the chamber 11′ of the dosing actuator 13′ and places the chamber 11′ in communication with the channel 16 of the feed nozzle 17′. When the moulding assembly 50 is not bearing against the injection head 50, the valve is in low position, such that the plug 22 blocks the inlet orifice of the channel 16 of the feed nozzle 17′ while the runner 15 is placed in communication with the chamber 11′ of the dosing actuator 13′.

The moulding assembly 50 is actuated in the direction of the injection head 10 by means of an actuator 500 located at the workstation where the injection press 100 is located.

The group of punch-carriers 40 is mounted on the rotary table 400 so that it can slide along a vertical axis, parallel to the axis of rotation of said rotary table. When the moulding assembly 50 is located at the injection head, the die-carrier assemblies 30 and the punch-carrier assemblies 40 being closed and locked, the actuator 500, also acting in the vertical direction, drives the moulding assembly 50 toward the injection head 10 and exerts an upward bearing force throughout the entire duration of the injection operation.

What is claimed is:

1) A process for the simultaneous injection moulding of plastic material in several mould cavities, wherein a moulding tool is used comprising an injection head integral with the injection press and a moulding assembly, the plastic material being injected under pressure by passing through runners provided in the injection head and maintained at temperature, said runners opening in the mould cavities, the moulding assembly comprising two mobile parts that are mobile in relation to one another and the assembly of which allows said mould cavities to be formed and the spreading apart of which allows the moulded parts to be ejected, the moulding assembly also comprising a manoeuvring device that opens, closes and locks said mobile parts and exerts a sufficient force to prevent opening during the injection, wherein none of said mobile parts of the moulding assembly is secured to the injection head, the moulding assembly coming into contact with said injection head and bearing against it only when it is in closed position and locked in order to fill the mould cavities by injecting plastic material.

2) The process according to claim 1, wherein the mobile part of said moulding assembly that is designed to bear against said injection head is equipped with at least one injection nozzle at the outlet of the runner.

3) The process according to claim 2, wherein said injection head is equipped with at least one feed nozzle at the opening of said runner and opposite of which is placed the injection nozzle.

4) The process according to claim 3, wherein said injection nozzle is equipped with a surface, preferably spherical, complementary of the surface of the feed nozzle to which it is associated, thus enabling correct alignment of said injection nozzle and said feed nozzle when said moulding assembly comes into contact with said injection head.

5) The process according to claim 2, wherein said injection nozzle is heated by a heating element, which can preferably be adjusted individually.

6) The process according to claim 1, wherein said injection head is equipped with at least one dosing actuator, supplied by a runner and which allows a controlled quantity of plastic material to be injected into the mould cavity associated with said runner.

7) The process according to claim 6, wherein said dosing actuator is associated with a valve which, when the moulding assembly is not bearing against the injection head, allows the channel of the feed nozzle to be plugged and the chamber of the dosing actuator to be filled and which, when the moulding assembly is bearing against the injection head, blocks the admission port of the runner in the chamber of the dosing actuator and places said chamber in communication with said channel of said feed nozzle.

8) The process according to claim 7, wherein said injection head is equipped with as many dosing actuators and valves as there are runner outlets, said dosing actuators and said valves being able to be activated individually so that said injection head can remain permanently fastened to the injection press, while the moulding assembly designed to be supplied by said injection head comprises a number of cavities less than or equal to the number of runner outlets.

9) The process according to claim 1, wherein at least one moulding assembly is mounted on an indexed rotary table operating in a step-by-step manner and serving several workstations, the injection press equipped with said injection head being placed at one of the workstations.

10) The process according to claim 9, wherein said moulding assembly is actuated in the direction of said injection head by means of an actuator located outside said rotary table, said actuator being placed at the workstation where said injection press is located, one of the mobile parts of the moulding assembly being mounded on said rotary table so that it can slide along an axis (A) parallel to the axis of rotation of said rotary table in such way that, when the moulding assembly is present, its mobile parts being closed and locked, said actuator, also acting in the axial direction, drives said moulding assembly toward said injection head and exerts a bearing force throughout the entire duration of the injection operation.

11) The process according to claim 9, wherein a rotary table divided into n sectors can be used, n being an integer typically between 2 and 24, each sector being occupied by m moulding assemblies, m being an integer typically between 2 and 8, each of the mobile parts of a moulding assembly being able to be grouped with the corresponding mobile parts of other moulding assemblies in such a manner so that there are only two assemblies of m mobile parts to be actuated in order to open, close and lock m moulding assemblies.

12) The process according to claim 9, wherein bodies are injection moulded that have rotational symmetry and at least one open end, such as flexible tube blanks or any other recipient having a bottom, possibly equipped with an orifice, connected by one end to a cylindrical or conical side wall, the other end of which is open, each moulding assembly comprising a male part, referred to as the punch, and a female part referred to as the die, said m punches being housed in a punch-carrier assembly, preferably sliding axially on said rotary table.

13) The process according to claim 9, wherein, upstream from the injection station, at a stage where the moulding assembly is still open, at least one workstation is assigned to the placement of parts such as skirts, inserts or labels into the cavity of one of the mobile parts of said moulding assembly.

14) The process according to claim 13, in which, downstream from the station supplying parts such as skirts, inserts or labels, a control device is used to check the presence and/or correct positioning of said parts in the mould cavities, and, upon detecting a fault in a cavity, action is taken on the dosing actuator and the valve associated with the faulty cavity so that injection does not take place in said cavity.

15) A moulding tool comprising an injection head designed to be mounted on an injection press and a moulding assembly, said injection head comprising runners and being equipped with heating elements, the moulding assembly comprising two mobile parts that are mobile in relation to one another and the assembly of which allows mould cavities to be formed and the spreading apart of which allows the moulded parts to be ejected, said moulding assembly also comprising a manoeuvring device that opens, closes and locks said mobile parts and exerts sufficient force to prevent opening during injection of the plastic material, characterised in that none of said mobile parts of the moulding assembly are secured to the injection head, the moulding assembly coming into contact with said injection head and bearing against it only when it is in closed position and locked in order to fill the mould cavities by injecting plastic material.

16) The moulding tool according to claim 15, wherein the mobile part of said moulding assembly, which is designed to bear against said injection head, is equipped with at least one injection nozzle at the outlet of a runner.

17) The moulding tool according to claim 15, wherein said injection head is equipped with feed nozzles located at the opening of said runners and opposite of which is placed said injection nozzles.

18) The moulding tool according to claim 17, wherein said injection head is preferably equipped with at least one valve that plugs the channel of the feed nozzle when the moulding assembly is not bearing against said injection head.

19) The moulding tool according to claim 15, wherein said injection nozzles are heated by a heating element, which can preferably be adjusted individually.

20) The moulding tool according to claim 15, wherein said injection head is equipped with at least a dosing actuator, supplied by a runner and which allows a controlled quantity of plastic material to be injected into the mould cavity associated with said runner.

21) The moulding tool according to claim 20, wherein said dosing actuator is associated with a valve which, when the moulding assembly is not bearing against the injection head, allows the channel of the feed nozzle to be blocked and the chamber of the dosing actuator to be filled and which, when the moulding assembly is bearing against the injection head, blocks the admission port of the runner in the chamber of the dosing actuator and places said chamber in communication with the channel of the feed nozzle

22) A machine for moulding plastic parts at high speed, comprising an injection press and at least a moulding tool according to claim 15, further comprising an indexed rotary table operating in a step-by-step manner and serving several workstations, said injection press equipped with said injection head being located on one of the workstations and at least one moulding assembly being mounted on said rotary table.

23) The machine according to claim 22, wherein the manoeuvring device that opens, closes and locks said mobile parts of the moulding assembly is mounted on said rotary table.

24) The machine according to claim 22, wherein said moulding assembly is actuated in the direction of said injection head by means of an actuator located outside said rotary table, placed on the workstation where said injection press is located, one of the mobile parts of the moulding assembly being mounted on said rotary table so that it can slide along an axis (A) parallel to the axis of rotation of said rotary table in such way that, when the moulding assembly is present, its mobile parts being closed and locked, said actuator, also acting in the axial direction, drives said moulding assembly toward said injection head and exerts a bearing force throughout the entire duration of the injection operation.

25) The machine according to claim 22, wherein said rotary table is divided into n sectors, n being an integer between 2 and 24, preferably between 4 and 12, even more preferably yet between 6 and 8, each sector being occupied by m moulding assemblies, m being an integer typically between 1 and 8, preferably between 4 and 6.

26) The machine according to claim 25, wherein each of the mobile parts of a moulding assembly is grouped with the corresponding mobile parts of other moulding assemblies in such a manner so that there are only two assemblies of m mobile parts to actuate in order to open, close and lock said m moulding assemblies.

27) The machine according to claim 22, wherein a workstation is provided upstream from the injection station where, the moulding assembly still being open, a device allows at least one insert or one label to be placed in at least one cavity of one of the mobile parts of at least one moulding assembly.
